(19) United States
(12) Patent Application Publication
(10) Pub. No.: US 2005/0015030 A1
(43) Pub. Date: Jan. 20, 2005

(54) Apparatus for combined application of massage, accupressure and biomagnetic therapy with improved steel ball supports

(76) Inventors: Patrick Bousfield, Middlesex (GB); David Leason, Chappaqua, NY (US); Edward J. Ellis, New York, NY (US); Frank Leparik, Greenlawn, NY (US)

Correspondence Address: DARBY & DARBY P.C., P. O. BOX 5257, NEW YORK, NY, 10150-5257, US

(21) Appl. No.: 10/757,035

(22) Filed: Jan. 13, 2004

Related U.S. Application Data
(60) Provisional application No. 60/440,058, filed on Jan. 14, 2003.

(51) Int. Cl. A61H 15/00

(52) U.S. Cl. 601/113; 601/129; 601/131

(57) ABSTRACT

An apparatus for applying massage, accupressure and biomagnetic therapy to a subject is provided and the apparatus includes a housing having a proximal end and a distal end; a motor disposed within the housing and having a shaft; and a magnet disposed within the housing about the shaft. The apparatus further includes a rotor rotatably supported by the shaft at the distal end of the housing. The rotor has an exterior face which is remote from the magnet and which defines a plurality of entrances, an opposing interior face proximate to the magnet, and a seat more proximate to the magnet than the interior face which is in communication with each of the entrances. Each seat is affixed relative to the rotor at one or more locations proximal to the exterior face. A plurality of metal balls are provided and which are seatable against the seat and retained within the entrances of the rotor by a magnetic field emanating from the magnet. Each ball has a center and is universally rotatable about its center. The seat is constructed and positioned so that it precludes contact of the metal balls with the magnet and counters forces applied to the balls when the apparatus applies therapy to the subject.

### CROSS REFERENCE TO RELATED APPLICATIONS

This application claims the benefit of U.S. provisional patent application Ser. No. 60,440,058, filed Jan. 14, 2003 which is hereby incorporated by reference in its entirety.

### TECHNICAL FIELD

The present invention relates generally to handheld massage devices, and more particularly to a handheld apparatus that simultaneously provides massage, accupressure and biomagnetic therapy to an area of the body.

### BACKGROUND

There are a number of different massage devices that are designed for providing massage therapy, which can be a beneficial form of treatment for sore muscles and the like, and that pressure applied in combination with motion over a treatment area is a generally recognized form of treatment for stiffness, fatigue, soreness, muscle strains and/or disorders that can have detrimental effects on an athlete's progress in training and conditioning programs. This is particularly evident in sports where the intent of training is to facilitate peak performance, such as track and field, gymnastics, swimming, wrestling, skating, and weight lifting and, to some extent, basketball, baseball and football. The massage devices can range from being hand held units to wall mounted units and can be electrically powered or powered by another means, such as water pressure.

It is known to construct a single device that provides a number of different therapeutic treatments and more specifically, combines a massaging action with accupressure therapy and biomagnetic therapy. This is shown in U.S. Pat. No. 6,102,875 to Jones in which a handheld apparatus for simultaneously applying massage, accupressure and biomagnetic therapy to an area of the human body is provided. While the apparatus disclosed in the '875 patent is satisfactory for its intended use, it suffers from a number of design flaws that limit the overall performance of the apparatus and more importantly, can lead to malfunction or failure of the apparatus. More specifically, the apparatus requires that each aperture that receives one ball has a plurality of spacer tabs that hold the ball out from the inner edge of the aperture as well as away from the magnet. The tabs provide a point of contact with the ball as opposed to the ball contacting the inner edge of the aperture or the magnet itself.

Unfortunately, this type of construction is not very robust since the tabs can easily become bent or break away from the surrounding structure during normal use of the apparatus. For example, a user grips the housing during normal use and holds it against an area of the human body where the therapy is desired. As the user holds the apparatus against the skin of the human body, a force is applied to the housing in a direction toward the human body. Forces in other directions are also applied to the apparatus and, more specifically, forces are applied against the balls when the balls are pressed against the human body. These forces generally are in an opposite direction relative to the forces being applied to the housing to position the apparatus against the human body.

The tabs are provided as part of the apertures formed in the rotor and importantly, the tabs define the sole contact points for the balls. Thus, any forces that are applied to the balls are transferred directly to the tabs. Thus, the tabs have a number of different forces applied thereagainst during normal use of the apparatus. The human body naturally resists the applied force of the apparatus against his skin by applying forces against the balls in opposing directions (e.g., in directions opposite the forces applied to the housing) and this places the tabs under stress. If the tabs bend or break off, the entire functional purpose of having the tabs is defeated since the balls can then become lodged within the aperture and gravitate toward the magnet, both of which are undesirable effects.

The apparatus of the '875 patent is also limited in that it only has a single massaging action, namely, the rotation of the rotor with the balls rotating within the apertures formed in the rotor. Often times, a user will want an additional massaging action or a choice between at least two massaging actions since one massaging action may be better suited for one type of discomfort or pain.

It is therefore desirable to provide a single unit that can provide more than one type of massaging action and is of a robust design that is particularly suited for normal applications.

### SUMMARY

The present invention pertains to an apparatus for simultaneously applying massage, accupressure and biomagnetic therapy to an area of the human body. By combining the benefits of massage, accupressure and biomagnetic therapy, the present invention can help stimulate the body's natural electromagnetic energy. For example, the human body contains about 4 to 5 grams of iron which is present in hemoglobin. Hemoglobin contains positive and negative ions and, when a magnetic field is applied to an area on the body, magnetic waves are believed to pass through the soft tissues so as to induce secondary currents. We are told by the Jones patent, for example, that when muscle tissue is damaged, the area immediately emits a positive magnetic charge, and that positive charge may stagnate the natural flow of blood and oxygen. By applying an external magnetic field to the affected tissue, it seems reasonable to conclude that the ionic movement of hemoglobin can be accelerated and the body's neural receptors can be augmented.

In one exemplary embodiment, an apparatus for applying massage, accupressure and biomagnetic therapy to a subject is provided and the apparatus includes a housing having a proximal end and a distal end; a motor disposed within the housing and having a shaft; and a magnet disposed within the housing about the shaft. The apparatus further includes a rotor rotatably supported by the shaft at the distal end of the housing. The rotor has an exterior face which is remote from the magnet and which defines a plurality of entrances, an opposing interior face proximate to the magnet, and a seat more proximate to the magnet than the interior face which is in communication with each of the entrances. Each seat is affixed relative to the rotor at one or more locations proximal to the exterior face. A plurality of metal balls are provided and which are seatable against the seat and retained within the entrances of the rotor by a magnetic field emanating from the magnet. Each ball has a center and is universally rotatable about its center. The seat is constructed and positioned so that it precludes contact of the metal balls with the magnet and counters forces applied to the balls when the apparatus applies therapy to the subject.

Further aspects and features of the exemplary apparatus disclosed herein can be appreciated from the appended Figures and accompanying written description.

### BRIEF DESCRIPTION OF THE DRAWINGS

The invention will be more fully understood by reference to the following drawings which are for illustrative purposes only:

FIG. 1 is a perspective side and bottom view of a handheld accupressure and biomagnetic therapy apparatus in accordance with a first exemplary embodiment;

FIG. 1a is an exploded perspective view of a head of the apparatus of FIG. 1;

FIG. 2 is a cross-sectional view taken along the line 2-2 of FIG. 1;

FIG. 3 is a partial cross-sectional view of a rotor with a corresponding massaging ball according to a first embodiment for use with the apparatus of FIG. 1;

FIG. 3a is an exploded perspective view in partial cross-section of a section of an aperture formed in the rotor of FIG. 3 with the ball being displaced therefrom;

FIG. 4 is a partial cross-sectional view of a rotor with a corresponding massaging ball according to a second embodiment for use with the apparatus of FIG. 1;

FIG. 4a is an exploded perspective view in partial cross-section of a section of an aperture formed in the rotor of FIG. 4 with the ball being displaced therefrom;

FIG. 5 is a partial cross-sectional view of a rotor having a dome structure formed as part thereof for receiving a corresponding massaging ball according to a third embodiment for use with the apparatus of FIG. 1;

FIG. 5a is an exploded perspective view in partial cross-section of a section of a dome structure formed in the rotor of FIG. 5 with the ball being displaced therefrom;

FIG. 6 is a partial cross-sectional view of a rotor having a cage structure formed as part thereof for receiving a corresponding massaging ball according to a fourth embodiment for use with the apparatus of FIG. 1;

FIG. 6a is a partial top perspective view of a section of the cage structure formed in the rotor of FIG. 5 with the ball being shown in phantom;

FIG. 7 is an exploded perspective view of a head according to another embodiment;

FIG. 8 is an exploded perspective view of a head according to another embodiment;

FIG. 9 is a cross-sectional view of a handheld accupressure and biomagnetic therapy apparatus that includes a dual mode massaging action in accordance with another exemplary embodiment, the apparatus being shown in a rest position;

FIG. 10 is a cross-sectional view of the apparatus of FIG. 9 shown the apparatus in an oscillating state;

FIG. 11 is a cross-sectional view of an alternative apparatus showing provision for a dual mode massaging action;

FIG. 12 is a cross-sectional view of a handheld accupressure and biomagnetic therapy apparatus that includes a dual mode massaging action in accordance with another exemplary embodiment, the apparatus being shown in a rest position;

FIG. 13 is a perspective view, partially exploded, of a handheld accupressure and biomagnetic therapy apparatus in accordance with another exemplary embodiment; and

FIG. 14 is a perspective view of a kit including the apparatus of FIG. 1 and a plurality of heads for attachment thereto along with corresponding balls.

### DETAILED DESCRIPTION OF THE PREFERRED EMBODIMENTS

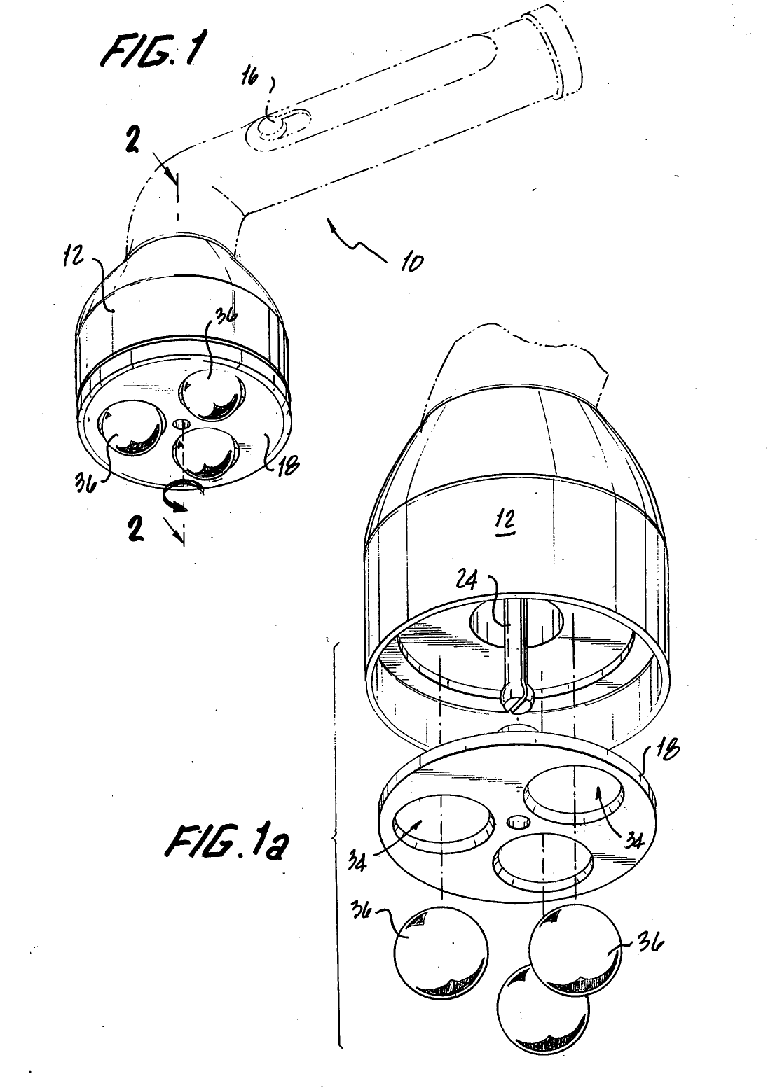

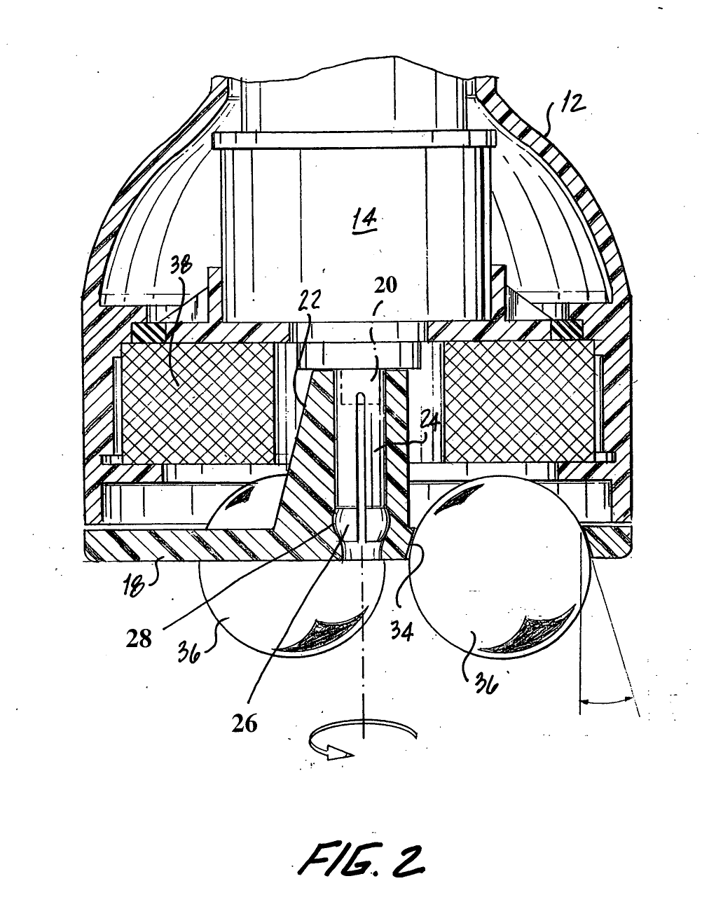

Referring first to FIG. 1, 1a, and FIG. 2, a handheld accupressure and biomagnetic therapy apparatus 10 in accordance with a first exemplary embodiment is generally shown. The apparatus 10 includes a housing 12 (e.g., split housing), containing an electric motor 14 which is preferably of a variable speed type. The speed of the motor 14 set by a combination “on/off” switch and speed control 16 using a conventional electronic speed control or the like (not shown). Alternatively, the motor 14 can operate at a fixed speed using direct drive or the motor 14 can be of a high speed type that is geared down through a conventional gear reduction arrangement. The motor 14 can also be of a reversible type and a direction reversing switch could be provided therewith. Power for the motor 14 can be provided by internal batteries (not shown) or an external power supply coupled to the motor 14 by a power cable (not shown) in any conventional manner.

A disc-shaped rotor 18 is coupled to the motor 14 using a shaft 20 such that the rotor 18 will rotate about the axis of the shaft 20 when the motor 14 is operational. The rotational speed of the rotor 18 is preferably variable between approximately 25 to 75 rpm, which is determined by the speed of the electric motor 14. Preferably, the rotor 18 includes a central collar 22 which is coupled to the shaft 20 by means of an intermediate sleeve 24 that is pressed onto the shaft 20. The sleeve 24 typically has a flared circumferential end 26 that engages an annular detent 28 in the collar 22. In this way, the rotor 18 can be removed from shaft 20 by separating the collar 22 from the sleeve 24 with a longitudinal pulling motion. Once removed, the rotor 18 can be cleaned, sterilized, replaced or swapped for a different rotor 400, 450, etc. Alternatively, the collar 22 can be coupled to the shaft 20 using one or more set screws (not shown) or other conventional coupling means. In addition, a fan (not shown) can be coupled to a shaft (not shown) extending from the opposite end of the motor 14 for cooling purposes as described in U.S. Pat. No. 6,102,875 to Jones, the entirety of which is hereby incorporated by reference.

Referring also to FIGS. 1a and 2, the rotor 18 has a plurality of peripherally spaced apertures 34 in which metal balls 36 are placed. According to one exemplary embodiment, there are three apertures 34 and three balls 36 arranged in a triangular fashion as shown so as to provide a “kneading” motion during rotation. It will be appreciated that kneading motion can also be produced with fewer balls, but with a longer time between repeat contact with an area. Conversely, additional balls will decrease the time between repeat contact for a given rotational speed of the rotor. The apertures 34 are also described hereinafter as having entrances formed at the exterior rotor face and exits formed at the interior rotor face.

While the balls 36 can be held in the rotor 18 in a variety of conventional ways, they are preferably held in place using one or more magnets 38 positioned between the motor 14 and the rotor 18 and adjacent to the balls 36. The magnet 38 is preferably annular in shape to match the shape of the rotor 18 with the shaft 20 and the collar 22 extending through the center thereof. Alternatively, the magnet 38 can be a plurality of magnets or magnet segments placed around the periphery of housing 12. In this first exemplary embodiment, each aperture 34 in the rotor 18 is of a tapered construction in that the wall of the rotor 18 that defines the aperture 34 comprises a continuous, tapered edge. In this precise embodiment, the aperture 34 is tapered inwardly toward the face of the rotor 18 that is closest to the magnet 38. The aperture 34 therefore is constructed so that it has a variable diameter with the diameter of the aperture 34 at the face of the rotor 18 closest to the magnet 38 being less than a diameter of the ball 36. As a result, the ball 36 contacts only a section of the wall defining the aperture 34 since the diameter at other sections of the aperture 34 is greater than the diameter of the ball 36. In other words, the balls 36 have limited points of contact and this reduces the friction as the balls 36 rotate. Yet, the tapered edge provides a substantially continuous band of material, preferably integral with the rotor 18, and so has mechanical strength to withstand the range of forces encountered when using the device free of bending or breakage. In other words, a substantially continuous abutment is disposed between each entrance and each exit with the abutment engaging the metal ball 36 and preventing the metal ball 36 from contacting magnet 38, while simultaneously countering forces applied to the balls 36 when the apparatus applies therapy to the subject.

By making the balls 36 from steel, iron or the like, they will be held in place by the magnet 38 and freely rotate about their own central axes (CA) when the rotor 18 rotates and pressure is being applied to an object such as a person undergoing therapy. Further, since the balls 36 are made from steel or like magnetic material, magnetic force from the magnet 38 will be transferred through the balls 36 and to tissue contacting the balls 36 during use of the apparatus.

The magnet 38 is typically a 1000 Gauss magnet, which provides for approximately 480 Gauss to be present at the point of contact between the balls 36 and the tissue. This will provide a safe and therapeutic modality. However, the apparatus may be contra indicated for some persons. It will be understood that other magnets of differing strengths can be used so long as they sufficiently hold the balls 36. Also, an electromagnet can be used to provide variable Gauss outputs.

It will be appreciated that, instead of using the magnet 38 to hold and supply the magnetic energy, the balls 36 could themselves be made from a magnetic or magnetized material. However, to do so would require a complicated race or carrier to hold them in place with the rotor 18 in a way which will allow the balls to freely rotate in any direction about their central axes. Additionally, the amount of magnetic force applied could not be easily varied where the balls themselves are magnetic. In contrast, the magnet 38 could be replaced with a stronger or weaker magnet to change the magnetic field without having to replace the balls 36. It will also be appreciated that the balls 36 could be replaced with cylindrical rollers arranged around the periphery of the rotor 18. Also, the balls 36 could be made oblong or another non-spherical shape if desired. However, spherical balls are preferred because they can rotate in any direction about their central axes (CA), whereas cylindrical rollers would rotate only about their longitudinal axes and oblong balls would rotate with a non-uniform motion.

While the present invention applies accupressure using rotating balls, physical stimulation could also be applied by substituting a conventional electromechanical or electromagnetic vibrator for the motor 14 and alternatively a dual-mode massaging action of acupressure and vibration can be created as described below. A backing plate or the like (not shown) can be coupled to the collar 22 and positioned in contact with the balls 36 between the balls and the magnet 38. If reciprocating motion or the like is then imparted to the collar 22 and backing plate, it transmits vibrations to the balls 36. The balls 36 “bounce” over the area of the body being treated due to this motion. In this arrangement, the balls 36 still are held in place with the magnet 38 or can instead be made of a magnetic material themselves to provide for simultaneous application of biomagnetic therapy. It is also contemplated that vibration and rotational motion of the balls 36 could be combined. The construction of motor driven handheld vibrators is well known in the art and, therefore, is not described in detail herein.

Accordingly, the embodiments of the present invention provide a massage product that enhances the healing process and assists in minimizing rehabilitation time. The apparatus allows a therapist or even the individual themselves to apply gentle massaging pressure directly to the muscle. The magnet holding the balls in place allows the balls to freely rotate over the muscle in a circular motion. This action creates a kneading effect over the soft tissues of the muscle minimizing the resistance created by rolling over the muscle. The rotating motion of the apparatus combined with application of magnetic force can help to eliminate toxins and waste products and replenish the area with oxygen-rich blood and nutrients. The increased concentrations of ions in the hemoglobin are believed to stimulate the autonomic nervous system to dilate the capillaries, resulting in increased overall circulation, and to provide for the effective removal of waste products. The muscle's natural healing process can thereby be enhanced, which may further bolster the area's resistance to degenerative effects. In addition to potentially increasing the flow of blood to the soft tissues and bones, the ion concentrations across the nerve axons may increase the axon resting membrane potential. It has been postulated that the natural energy balance of sodium (Na+), potassium (K+) and chloride (Cl−) located along the axon membranes are augmented so when a “pain” stimulus is received the impulse is not intense enough to depolarize and transmit a signal. Once the axon's resting membrane potential drops from 70 mV to 55 mV (i.e., threshold potential), a pain stimulus is sent to the brain. In theory, chronic pain is a result of a decreased resting potential (i.e., 60 mV), thus only a small change (−5 mV) is needed to produce pain. More importantly, pain results in an impulse which may decrease performance and/or training quality. The embodiments herein provide a magnetic field that passes through in a direction perpendicular to the ionic movement of the axon which produces a voltage. This voltage may add to the nerve's resting potential and raise its threshold, making it less likely to depolarize. Also, the deflecting action of the magnetic filed of the ions could potentially make it more difficult for the ions to pass through the nerve membrane. The entire excitation of pain can thus be influenced and the subjective perception of pain changed. Consequently, the present invention can both ease pain and increase circulation, and invigorate muscles so that the athlete can recover from injury more quickly and without a significant loss in performance.

The construction of FIGS. 1, 1a, and 2 offers a much more robust design compared to the tab construction in the '875 patent since the tapered apertures 34 support the ball 36 better and offer increased strength to resist the forces that are applied to the ball 36, etc. Because a substantially continuous and preferably entirely continuous annular section is defined at one end of the tapered aperture wall to contact the ball 36 (as opposed to a plurality of fragile tabs), forces that are applied against the ball 36 are dispersed more uniformly through the rotor 18 as opposed to being absorbed locally by tabs as is the case in the prior art design. It is precisely this localization of forces that causes stress that leads to damage and potentially to the destruction of the tabs in the prior art design.

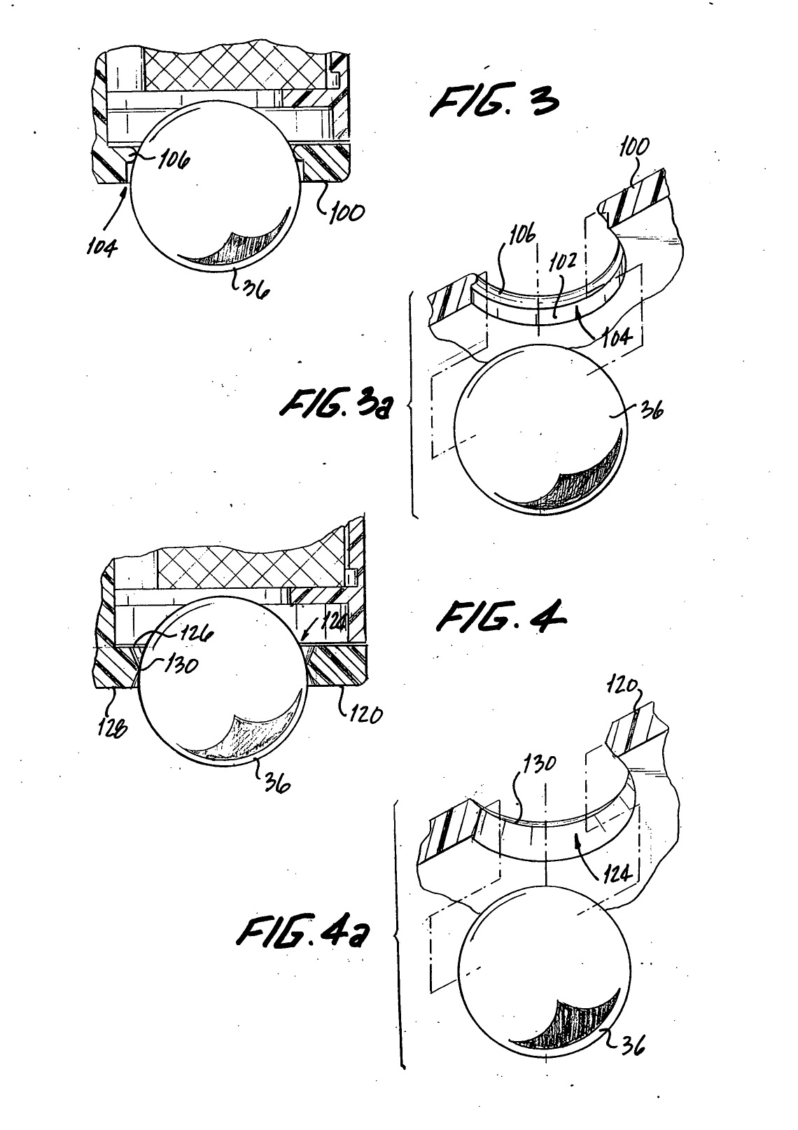

Now referring to FIGS. 3 and 3a, a second embodiment of the present invention is illustrated. In this embodiment, a disc shaped rotor 100 is used instead of the disc-shaped rotor 18. The rotor 100 is similar to the rotor 18 except that it includes apertures 102 that are defined by a partially beveled or straight surface 104 and a substantially continuous (if not entirely continuous) ring-like projection 106 that is formed at one end of the beveled surface 104. The beveled surface 104 thus is an annular beveled surface and the ring-like projection 106 is preferably formed at the end of the beveled surface 104 that is closest to the magnet 38. The opening defined within the ring-like projection 106 has a diameter that is less than the diameter of the opening at any point along the beveled surface 104 and further, the diameter at the ring-like projection 106 is less than the diameter of the ball 36. As a result, the ball 36 contacts only the ring-like projection 106 of the aperture 102 since the diameter at other sections of the aperture 102 is greater than the diameter of the ball 36. In other words, the balls 36 have limited points of contact and this reduces the friction as the balls 36 rotate. Moreover, the outer surface of the spherical balls 36 continuously revolve and spin within the aperture 102 while being seated upon ring 106 due to the magnetic attraction force of the magnet 38. While the ring-like projection 106 can be a member that has surfaces that generally converge to a point, it will be appreciated that the ring-like projection 106 can be constructed so that it includes a more rounded surface that contacts and seats against the balls 36.

The construction of FIGS. 3 and 3a offers a much more robust design compared to the tab construction in the '875 patent since the tapered aperture 102, and more specifically, the ring-like projection 106 thereof, supports the ball 36 better and offers increased strength to resist the forces that are applied to the ball 36, etc. Because the ring-like projection 106 is an annular member that preferably completely surrounds a portion of the ball 36, as opposed to a plurality of fragile tabs, forces that are applied against the ball 36 are dispersed more uniformly through the rotor as opposed to being absorbed locally by tabs as is the case in the prior art design. The present design is a more robust design without diminishing the performance characteristics of the apparatus. When the ring 106 is continuous, pressing forces of the ball 36 upon skin are accommodated over a substantially greater area, reducing the pressure on any given point on the ring 106 as compared to when tabs are employed. This results in a more durable product.

However, it will also be appreciated that the ring-like projection 106 does not have to be a completely annular member but rather it can be segmented to form a number of different arcuate sections with spaces between adjacent sections. More specifically, spaces which are free of material are incorporated into the structure of the ring-like projection 106 so as to define arcuate sections with spaces therebetween. In this manner, the contact area between the ball 36 and the rotor 100 is reduced since the ball 36 does not contact a completely annular surface but rather it contacts a number of smaller arcuate shaped segments.

It will also be appreciated that the substantially continuous abutment (e.g., ring-like projection 106) disposed between each entrance and a corresponding exit can be in the form of a permanent magnet affixed to the rotor with its magnetic poles arranged in opposite polarity to that of the magnet, whereby the metal balls normally float in spaced relation to the ring magnet within the apertures.

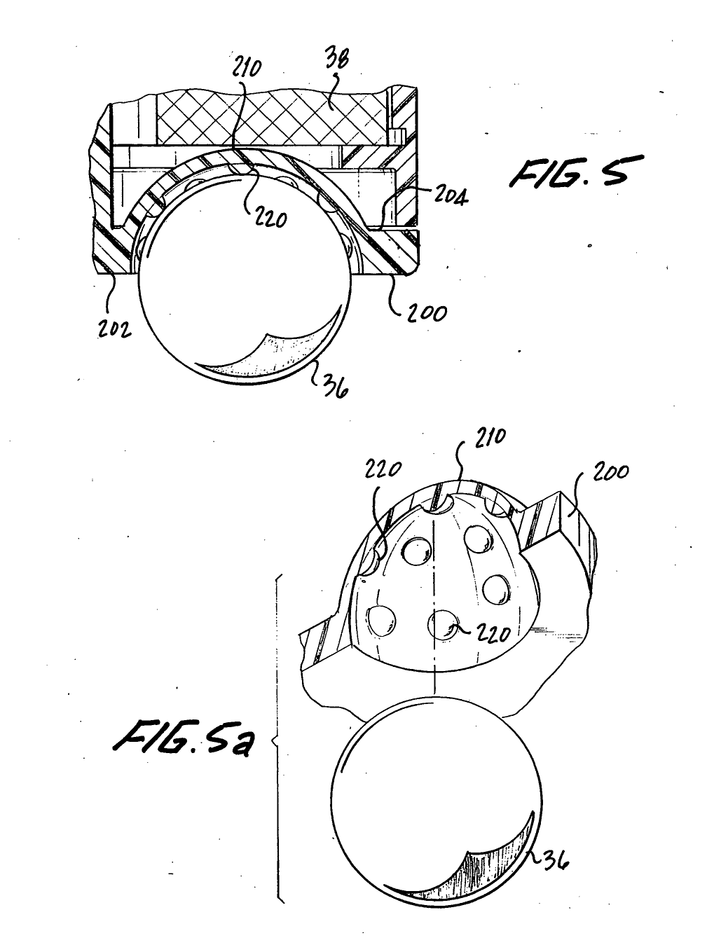

Now referring to FIGS. 4 and 4a in which yet another embodiment of the present invention is illustrated. In this embodiment, a disc shaped rotor 120 is provided in place of rotor 18. The disc shaped rotor 120 has a number of apertures 122 that are formed completely therethrough. Each aperture 122 is defined by a wall 124 that extends between a first face 126 of the rotor 120 and a second face 128 of the rotor 120. The wall 124 tapers inwardly from each of the first face 126 and the second face 128 to a tip 130. In other words, the wall 124 tapers inwardly from the first face 126 to the tip 130 and then reverse tapers to the second face 128. While, the tip 130 can be a point, the tip 130 can be formed as a more rounded member. In both embodiments, the tip 130 actually is an annular structure. As with the other embodiments, the tip 130 is the section of the aperture 122 that has the smallest diameter as compared to the surrounding beveled sections of the wall 124 that terminate in the tip 130. As a result, the ball 36 contacts only the tip 130 of the aperture 122 since the diameter at other sections of the aperture 122 is greater than the diameter of the ball 36. In other words, the balls 36 have limited points of contact and this reduces the friction as the balls 36 rotate. The tip 130 also serves to prevent the balls 36 from passing completely through the apertures 122 since there are sections of the apertures 122 that have a diameter greater than the diameter of the ball 36. In the illustrated embodiment, the tip 130 is shown as being approximately in the middle between the first face 126 and the second face 128; however, it will be understood that the tip 130 can be formed close to one of the first and second faces 126, 128. In other words, the lengths of the beveled sections that are either side of the tip 130 and extend to one of the first and second faces 126, 128 can either be the same length as in the illustrated embodiment or they can be different as is the case when the tip 130 is not is the center between the first and second faces 126, 128. Like the prior embodiments, this embodiment can provide a continuous bearing surface for a freely revolving and spinning ball 36, and encounters less pressure at contact points with the balls 36 due to its greater line of contact yet still provides an engineered support imposing low friction to the balls.

The construction of FIGS. 4 and 4a offers a much more robust design compared to the tab construction in the '875 patent since the tip 130 supports the ball 36 better and offers increased strength to resist the forces that are applied to the ball 36, etc. Because the tip has an annular surface that contacts the ball 36 as opposed to a plurality of fragile tabs, forces that are applied against the ball 36 are dispersed more uniformly through the rotor 120 as opposed to being absorbed locally by tabs as is the case in the prior art design. As with the prior embodiments, the shape and size of the contact area in this embodiment provides increased support of the ball 36 and dispersement of forces applied to the balls 36 during normal use when the balls 36 are pressed into the human body.

However, it will also be appreciated that the tip 130 does not have to be a completely annular member but rather can be segmented to form a number of different arcuate tip sections with spaces between adjacent sections. More specifically, spaces which are free of material are incorporated into the tip structure so as to define arcuate tip sections with spaces therebetween. In this manner, the contact area between the ball 36 and the rotor 120 is reduced since the ball 36 does not contact a completely annular surface but rather it contacts a number of smaller arcuate shaped segments.

Now referring to FIGS. 5 and 5a in which another embodiment of the present apparatus is shown. In this embodiment, a disc shaped rotor 200 is provided in place of rotor 18. The disc shaped rotor 200 does not include a number of apertures as in the other embodiments but rather the disc shaped rotor 200 has a plurality of recessed, shaped sections 210 formed therein. This enables the mechanics within the housing 12 to better remain free to debris and dirt. The arrangement of the recessed, shaped sections 210 can be the same as the arrangement of the apertures in the other embodiments or it can be different. In one exemplary embodiment, the recessed sections 210 are in the form of generally hemispherically shaped domes that are formed in an inner face 204 of the rotor 200 with an outer face 202 being more distant from the magnet 38. When viewing the outer face 202 of the rotor 200, the dome structures 210 look like recessed hemispherical craters or depressions and when viewed on the opposite inner face 204, they appear as hemispherically shaped dome structures. In other words, the exterior or outer face 202 defines a plurality of entrances which are in communication with a seat (an surface of a portion of the dome structure 210) that is more proximate to the magnet 38 than the inner face 204 which is in communication with each of the entrances. The seat is affixed to the rotor 200 at the inner face 204 thereof.

The dome structures 210 preferably have a degree of curvature that is complimentary to the degree of curvature of the ball 36 so that the balls 36 can at least partially seat within the dome structures 210. The hemispherical surface of the dome structure 210 thus has a concavity sized to receive at least a portion of the metal ball 36. It will be appreciated that in this embodiment, the dome structure 210 has a solid surface and the thickness of the rotor 200 can be reduced in the areas of the dome structures 210 while still providing a robust structure that prevents the balls 36 from contacting the magnet 38. In other words, the curved sections of the rotor 200 can have a thickness that is less than the thickness of the other sections of the rotor 200. Because the rotor 200 is preferably formed of a plastic material, the provision of a solid structure (i.e., the dome structures 210) between each ball 36 and the magnet 38 does not adversely impact the magnetic energy that is supplied by the magnet 38 and the ball 36 is sufficiently held in place by the magnet 38, while still being free to rotate.

It will be appreciated that surface modifying features can be added to the recessed sections 210 so as to reduce the friction between the balls 36 and the walls surfaces of the dome structures 210 and thereby permit the balls 36 to more freely rotate. For example, a plurality of projections, e.g., bumps, 220 can be formed on the inner surface of the dome structures 210 to reduce the contact area between the balls 36 and the wall surfaces of the dome structures 210. These bumps 220 can be arranged in any number of patterns and the size and shape of the protrusions are also variable. By reducing the contact area between the balls 36 and the dome structures 210, friction between the two is likewise reduced and the balls 36 can freely rotate.

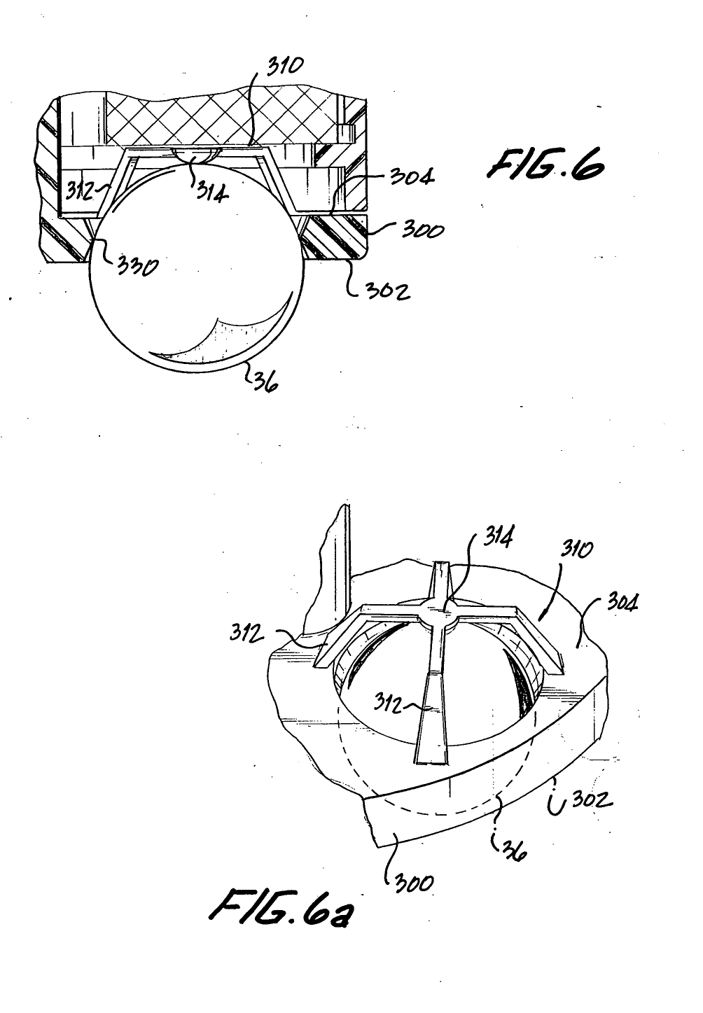

In yet another exemplary embodiment, the recessed sections formed in the rotor are constructed in the form of open, cage-like structures. More specifically and as illustrated in FIGS. 6 and 6a, a rotor 300 is provided and has a number of cage structures 310 that are formed as part thereof. The rotor 300 has an outer face 302 and an inner face 304 that faces the magnet 38. The cage structures 310 are similar to the dome structures 210 of FIGS. 5 and 5a with the exception that the cage structures 310 have perforated or open sections as opposed to the recessed sections 210 that are defined by solid walls. In other words and as illustrated, the cage structure 310 is dome shaped with the dome including a number of openings formed therein so as to define a plurality of structural support fingers 312 that converge and join another at a base 314. In the illustrated embodiment, there are four fingers 312 that converge at a disc shaped base (seat) 314 with openings 316 being formed between adjacent fingers 312. It will be appreciated that the number of shapes of the illustrated fingers 312 are merely exemplary and any number of modifications can be made to the fingers 312. Further, the base 314 is not limited to having a disc shape but rather it can have any number of other shapes.

Thus, the fingers 312 can be curved members since the cage structure 310 is in the form of a depression that is formed within the rotor 300 when viewing it from the outer surface thereof. The fingers 312 can therefore be constructed so that they curve inwardly and converge at the base 314. The exemplary cage structures 310 are in the form of precise-linear dimension and shape selected to seat the ball only at prescribed contact points. Moreover, in a variation, the members can follow a generally hemispherical contour with the members having a degree of curvature that is complementary to the degree of curvature of the ball 36 so that the balls 36 can at least partially seat within the cage structures 310. Compared to the embodiment of FIGS. 5 and 5a, the balls 36 have less contact points in this embodiment since the balls 36 preferably only contact the base 314 as opposed to a more significant contact surface in the embodiment of the dome structure of FIGS. 5 and 5a. It will also be appreciated that these are merely two exemplary types of cage constructions and a great number of other cage constructions are equally suitable as part of the rotor construction. For example, the cage can be formed of two intersecting curved finger members, where each finger is generally actuate in shape.

In all embodiments, the cage structure 310 has an interior space in communication with a respective entrance formed in the rotor and has a size sufficient to permit an associated metal ball to be received therein and a strength that counters forces applied to the balls when the apparatus supplies therapy to the subject.

The base (seat) 314 can be disc shaped but it also can be another shape, such as a square, and the base 314 is generally parallel to the inner surface of the rotor 300. As with the other embodiment, the contact area between the ball 36 and the cage structure 310 is minimized, and lines of force pressing against the ball when using the device are generally aligned with the base 314 between the ball 36 and the base 314.

In preferred embodiments, it is preferable for the cage to be constructed so that resistance between the ball and other ball-surrounding support members is minimized. Accordingly, the contact points (and surface areas) between the ball and the surrounding support member are minimized, such as by placing projections or protrusions or the like on the recessed wall or by opening the support member as by removing sections thereof to form openings or windows. As the number and area of the contact points are reduced, the friction between the ball 36 and the support member is reduced.

Preferably, the cage structures 310 are integrally formed as part of the entire rotor 300 structure and more specifically, the rotor 300, with the cage structures 310, is a molded plastic article.

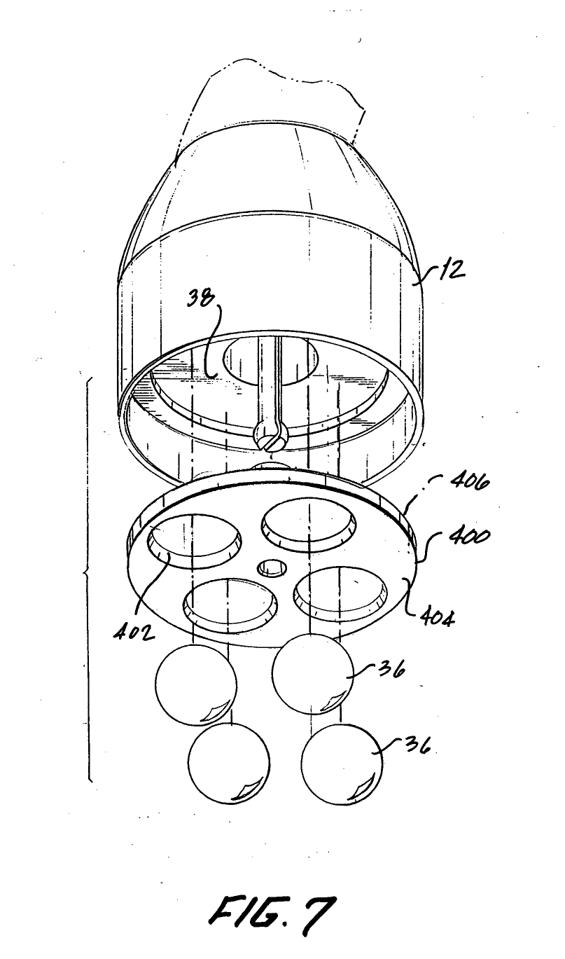

Turning now to FIG. 7 in which another aspect of the present apparatus is illustrated. In this embodiment, a rotor 400 is provided and is very similar to a rotor of any of the previous embodiments except that the number of apertures or ball holding features formed therein is increased. For purposes of simplification only, the embodiment of FIG. 7 is discussed in terms of being similar to the rotor 100 of FIG. 1a; however, it will be understood that the below described modification can be done to any of the other embodiments that are shown in FIGS. 3 to 6a.

Rotor 400 is a disc-shaped rotor that has at least four peripherally spaced apertures 402. The apertures 402 are similar to the apertures 34 in that they are tapered inwardly from an outer rotor face 404 toward an inner rotor face 406 with the diameter of the aperture 402 at the inner rotor face 406 being less than the diameter of the ball 36, thereby preventing the ball 36 from contacting the magnet 38.

Because the actual dimensions of the rotor 400 do not change compared to the earlier disclosed rotors, i.e., rotor 18, the dimensions of each aperture 402 are smaller than the dimensions of the aperture when there are less than 4 apertures formed in the rotor 400. In other words, the dimensions of each aperture decrease as more apertures are formed in the rotor 400. Consequently, the dimensions of the balls 36 also change so that the balls 36 can be received in the apertures 402 in the same manner as they were received in the other apertures. Because the rotor 400 includes at least four apertures 402, the dimensions of each ball 36 are decreased to permit each individual ball 36 to be at least partially received into one aperture 402 so that one or more sufficient contact points are also established.

Advantageously, the provision of additional apertures 402 and additional balls 36 as part of the rotor 400 and of the overall apparatus provide a different therapeutic massaging action. The massaging action that is felt by the user is different for an apparatus that uses four smaller balls 36 that are spaced differently compared to an apparatus that has three larger balls arranged generally in a triangle. Likewise, rotors that have more than four balls 36 will offer a different massaging action compared to those with less than four balls 36. Because of the ease of interchangeability between rotors, it is contemplated that a user can interchange one rotor for another rotor when the user wants a different massaging action by simply separating the collar 22 from the sleeve 24 with a longitudinal pulling motion and then the other rotor is simply installed by engaging the collar 22 thereof with the sleeve 24 by applying a force against the rotor. The present apparatus can thus be marketed so that it comes with a number of rotors that have either different dimensioned balls and/or different ball arrangements and the user can simply interchange rotors depending upon the type of massaging action that is required.

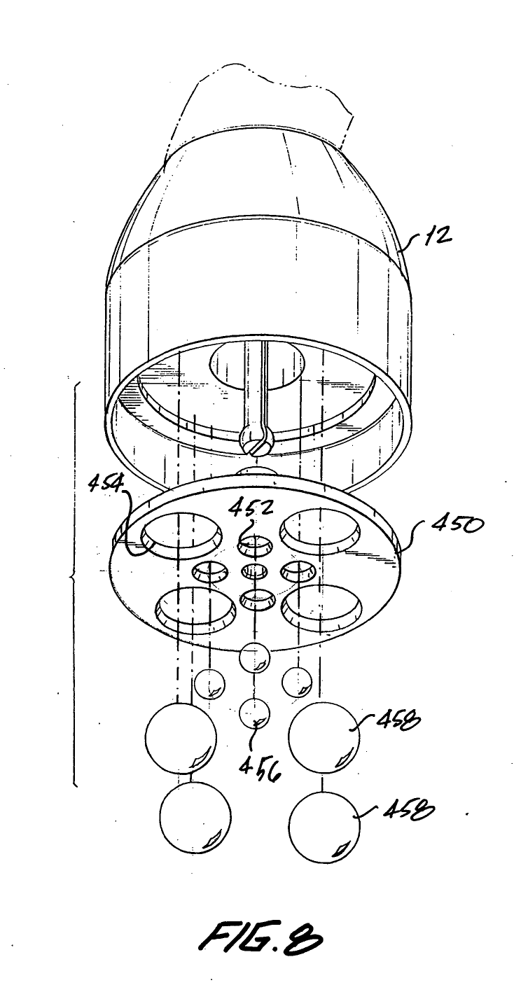

FIG. 8 illustrates an embodiment where a rotor 450 is provided with apertures of different dimensions. For example, a first set of apertures 452 are formed therein along with a second set of apertures 454. Each of the first set of apertures 452 have dimensions less than the dimensions of each of the apertures in the second set of apertures 454. Because the dimensions of the apertures 452, 454 vary, the corresponding balls that are received therein also are of different dimensions. For example, smaller balls 456 are received in the apertures 452 and larger balls 458 are received in the apertures 454. This results in a different massaging action being felt by the user due to two sets of balls being used. This embodiment can be operated, for example, with or without the smaller balls 456 being seated in the rotor 450.

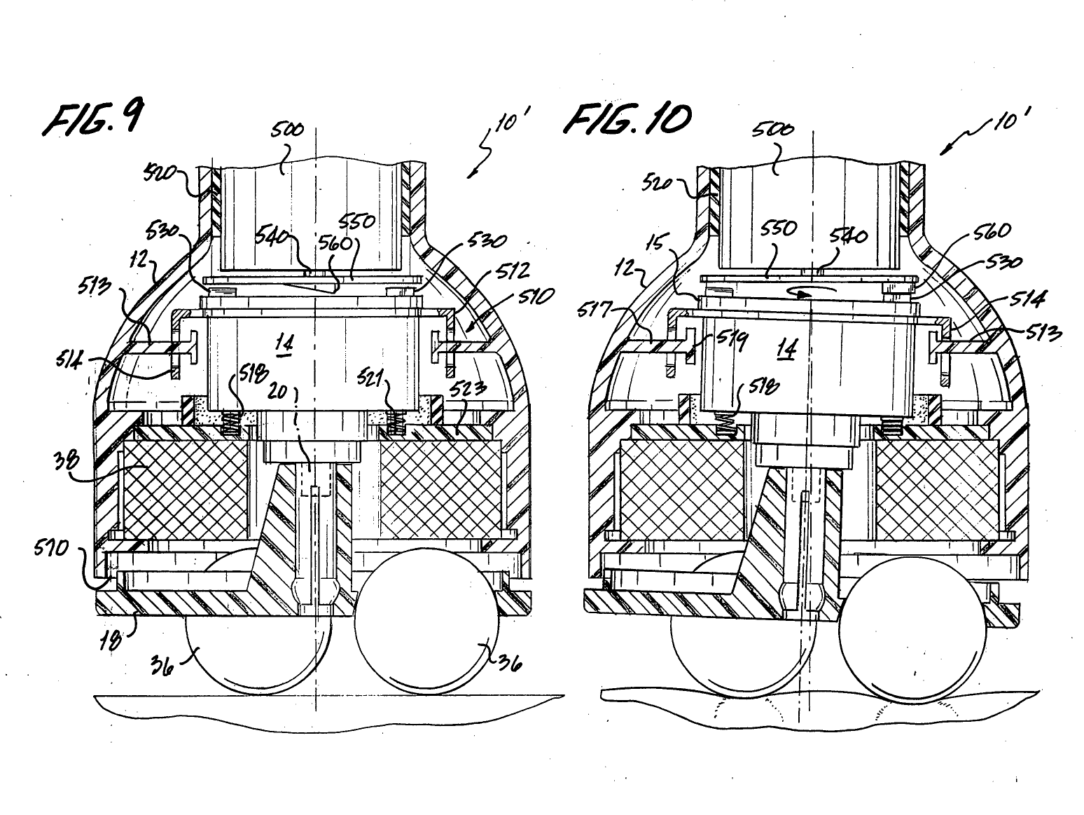

In yet another aspect of the present invention, an apparatus 10′ can include two modes of massaging action. One exemplary embodiment that includes two modes of massaging action is shown in FIGS. 9 and 10. In this embodiment, the controller has not only an “on/off” switch and speed control (which actuators may be combined together) but also includes a button or switch that permits the user to activate a second massaging action that supplements the first massaging action that is disclosed above. In one exemplary embodiment, the apparatus 10′ includes not only the motor 14 but also includes a second motor 500 or vibratory device that provides the second massaging action that supplements the first massaging action that is provided by the motor 14. The second massaging action is a vibratory/oscillating action or an undulating or wobbling action that is translated to the balls 36. In this embodiment, the motor 14 is coupled to the housing 12 so that it can rock back and forth (oscillate) if a force is applied thereto. For example and as illustrated in FIGS. 9-10, a mechanism 510 can be provided to permit pivoting of the motor 14 and includes a member 512 that is securely disposed around at least a portion of the motor 14 so that the motor 14 is supported and is also pivotable. One exemplary member 512 is a ring-like support structure that has a central opening formed therethrough for receiving the motor 14. The motor 14 can include a lip 15 so that when the motor 14 is disposed within the opening of the ring-like support structure 512, the lip 15 seats against an upper surface of the member 512. The member 512 includes at least one flange 514 that is integrally connected thereto at a peripheral edge of the member 512 and serves to pivotally attach the member 512 (and the motor 14) to the housing 12. In the illustrated embodiment, there are two flanges 514 that are positioned opposite one another along the circumferential edge of the member 512. The flange 514 can have a horizontal section that extends away from the member 512 and a vertical section that is parallel to the housing wall.

The member 512 can be pivotally attached to the housing 12 using any number of techniques including the use of a pivot pin 513 that extends through a slot 515 formed in the flanges 514. The slot 515 is a closed ended slot that receives the pivot pin 513 and permits movement of the pivot pin 513 therein to cause an up and down undulating motion of the motor 14 (and all parts attached thereto) when the second motor 500 is activated as will be described below. The slot 515 thus governs or restricts the range of travel of the pivot pins 513 within the flanges 514. One exemplary pivot pin 513 is formed as part of the inner surface of the housing 12 and includes a horizontal arm 517 with a head 519 formed at a distal end thereof that prevents the pivot pin 513 from becoming displaced from the slot 515. In other words, the pivot pins 513 are integral projections that protrude outwardly from the inner surface of the housing.

In this embodiment, the rest position for the motor 14 is one in which the shaft 20 thereof is substantially normal to the rotor 18. In order to ensure that the motor 14 is returned to this rest position after an applied force has been withdrawn after displacement (pivoting) of the motor 14, a biasing element 518 is provided for biasing the motor 14 toward the rest position. The biasing element 518 can be one or more springs that are coupled to the respective housing 12 and has a section that contacts and applies a biasing force against the motor 14 of a sufficient strength so that motor 14 remains in the rest position if no forces are applied thereto. In one exemplary embodiment, biasing elements 518 in the form of springs are disposed in grooves, notches or the like 521 that are formed in a base plate 523 this is disposed above the magnet 38. It will therefore be appreciated that the motor 14 is therefore in the form of a free floating motor that has a range of movement when forces are applied thereto.

Optionally, a damper 520 can be provided within the housing 12 to dampen any excessive vibration so that the user does not experience excessive vibration in the handle portion of the apparatus. The damper 520 can be formed of a resilient foam material that is disposed at a selective region of the housing 12. Preferably, the damper 520 is attached to the housing 12 at a location that is opposite the location around the second motor 500. However, the damper is constructed and positioned so that it does not restrict the rocking, pivoting action of the motor 14.

The motor 14 includes at least one projection (protrusion) or cam 530 formed as part thereof. More specifically, an upper surface 532 of the motor 14 includes at least one projection 530 that extends upwardly therefrom. Preferably, there are two projections 530 in the form of a sloped cam surface as illustrated. While the cams 530 can be spaced apart from one another in any number of different arrangements, one preferred arrangement is for the cams 530 to be spaced about 180 degrees apart from one another and arranged such that the sloped surfaces of each are facing in opposite directions as illustrated (to facilitate the wobbling action as described below). The height of the projection 530 is also variable since varying the height of the projection will alter the type of massaging action that is provided by the apparatus.

The second motor 500 has a shaft 540 that extends therefrom and is coupled to the second motor 500 so that the shaft is rotatingly driven. A rotatable platform or the like 550 is coupled to the free end of the shaft 540 with the platform 550 having a projection 560 or other feature formed thereon such that it protrudes away from an underside of the platform 550. For example, the projection 560 can be a bump or the like that is formed on the face of the platform 550. The platform 550 can be eccentrically mounted with respect to the shaft 540 to increase the oscillatory motion. In addition, the projection 560 can be in the form a cam surface, such as a sloped surface protrusion.

The second motor 500 is rigidly mounted to the housing 12 so that its shaft 540 is facing downwardly towards the motor 14. The shaft length 540 is selected so that the platform 550 is spaced slightly from the upper surface 532 of the motor 14 and importantly, the length is such that the projection 560 selectively aligns with and is planar to the projection 530 so that the two selectively engage one another when the second motor 500 is activated and the platform 550 rotates into a position where the projection 560 approaches and strikes the projection 530. As the two projections 530, 560 engage one another, the motor 14 pivots downwardly about the pivot pin since the force of the engagement of the driven projection 560 with the projection 530 overcoming the biasing force of the biasing element 518 and this results in the motor 14 pivoting downward. Because the motor 14 is coupled to the rotor 18 through the shaft 20, the striking/engagement between the projections 530, 560 is transferred to the shaft 20 and this shaft 20 moves to a position where it is no longer parallel to a central vertical axis of the housing. In other words, the downward pivoting of the motor 14 causes the rotor 18 to dip in one section thereof, while rising in another section thereof. The biasing elements 518 also facilitate this type of movement since when the projections 530, 560 engage one another, the biasing element 518 that is thereunderneath is compressed due to the downward driving action of the motor 14 caused by the contact between the projections 530, 560, while the other biasing element 518 is not compressed (and in fact can become slightly extended).

As soon as the projection 560 clears the projection 530, the motor 14 is naturally biased by biasing element 518 such that it returns to the initial state. Accordingly, the motor 14 pivots upwardly about the pivot point until it is in the rest position shown in FIG. 9. At the same time, the projection 560 is continuously rotating and therefore, the projection 560 strikes the other projection 530 and the process is repeated except that the other side of the motor 14 pivots downward this time. The speed of the motor 500 can be variable so that the striking pattern between the projections 530, 560 is variable. As the speed of the motor 500 is increased, the number of strikes per minute between the projections 530, 560 increases and this results in a different oscillatory action (a wobbling action) being felt by the user since the oscillating motion of the rotor 18 is increased.

In order to permit the rotor 18 to rock back and forth (oscillate or wobble), a clearance 570 can be built into the apparatus at the area where the rotor 18 and bottom edge of the housing 12 are located. In other words, the rotor 18 must be able to oscillate back and forth without contacting the housing 12. The oscillating action of the rotor 18 is illustrated in FIG. 10 where the different positions of the rotor 18 are shown. The rotor 18 is also simultaneously rotating due to the rotation of the shaft 20 by the motor 14 and therefore, this embodiment offers a dual mode massaging action since the rotor 18 not only spins but is also simultaneously rocking back and forth (oscillating or wobbling).

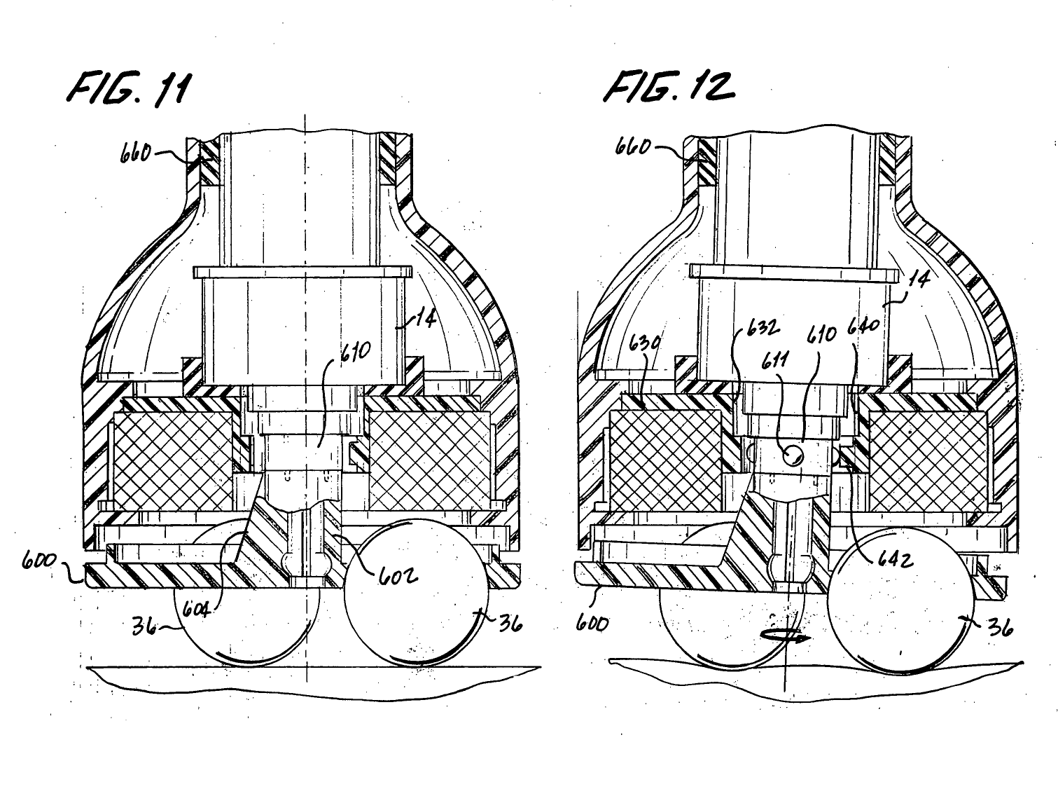

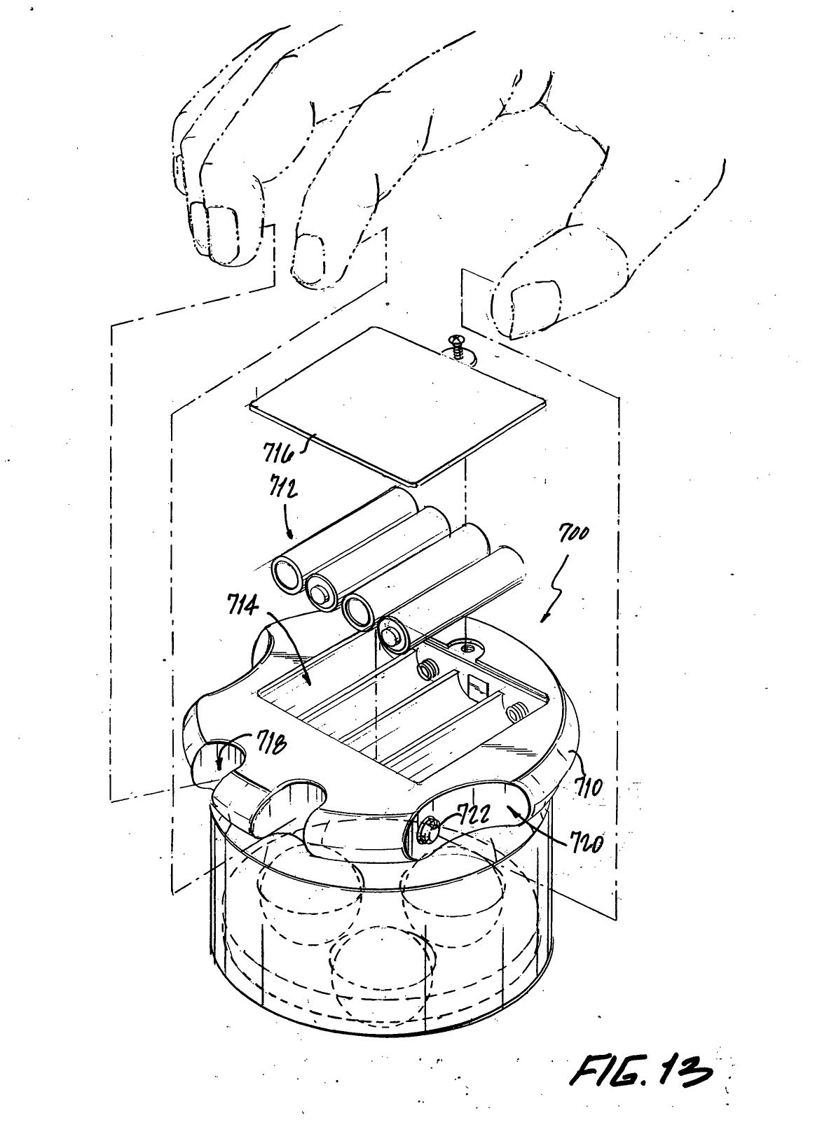

FIGS. 11 and 12 illustrate yet another embodiment that offers a provision for a dual mode massaging action and in the embodiment, a second motor is not required. In this embodiment, the rotor 600 is similar to rotor 18 of FIG. 1 with the exception that the collar 22 thereof is modified in the following manner. The collar 22 generally has a tubular shaped body 602 with a plurality of structural supports (e.g., fins) 604 that extend outwardly therefrom to provide increased structural integrity to the collar 22 since the fins 604 are integrally connected at one end to the rotor 600. Unlike the first embodiment of FIG. 1, the fins 604 do not extend completely to the motor 14 but rather they are terminated therefore such that a gap is formed between the tops of the fins 604 and an underside of the motor 14.

A spacer 610 is provided and is securely coupled to the tubular shaped body 602 so that the spacer 610 rotates with the collar 22 and relative to the motor 14. The spacer 610 can be securely coupled to the collar 22 using any number of techniques, including those that permit releasable interlocking of the spacer 610 to the collar 22. For example, the spacer 610 can have first features that interlocking mate with complementary second features that are formed in the tubular shaped body 602. In one exemplary embodiment, the mating between the first and second features is in the form of an interlocking key arrangement where, for example, one of the spacer 610 and the tubular shaped body 602 has projections (e.g., prongs) that seat within the complementary notches formed in the other of the spacer 610 and the tubular shaped body 602 so that the two parts interlock and are rotatable with one another.

The spacer 610 is constructed with a number of protrusions (e.g., nubs or bumps) 611 formed and spaced along an outer surface thereof. For example, the spacer 610 can have four, equally spaced nubs 611 formed along an outer surface thereof. The nubs 611 face the magnet 38. In the illustrated embodiment, the nubs 611 are hemispherically shaped protrusions. It will be understood that the size and number of protrusions 611 can be varied to provide different massaging actions as will be appreciated in view of the following discussion.

The motor 14 seats and is fixed on a support plate 630 that is disposed above the magnet 38. The support plate 630 is generally in the form of a ring shaped plate that has a central opening 632 to receive the shaft 20 of the motor 14. According to this embodiment, the underside of the support plate 630 includes an integral sleeve 640 that extends outwardly from the underside of the support plate 630. The sleeve 640 is an annular sleeve that has an opening formed therethrough for receiving the shaft 20 and is configured so that the sleeve 640 seats within the bore of the magnet 38. An outer surface of the sleeve 640 faces the magnet and can be slightly spaced from the magnet 38 or it can be placed into contact therewith since the sleeve 640 is preferably formed of a suitable plastic material. The sleeve 640 is thus a fixed element relative to the rotor 600 and the collar 610 thereof.

An inner surface of the sleeve 640 has at least one strike element 642 that is arranged so that it makes contact with the nubs 611 as the collar 610 rotates under the action of the motor 14. More specifically, the strike element 642 can be in the form of a cam surface (e.g., a ramped protrusion) that is formed on the inner surface of the sleeve 640. The ramp section of the exemplary strike element 642 in the form of a cam is arranged so that the nubs 611 contact first the bottom of the ramp and then travel up the ramp as the nubs 611 rotate due to the rotation of the shaft 20. The incline of the ramp is designed so that the traveling of the nub 611 along the ramp causes lateral displacement of the shaft 20 and therefore, the rotor 600 is also moved in the lateral direction. As soon as the nub 611 clears the strike element 642, the shaft 20 returns toward or to its normal rest position until the next nub 611 contacts the strike element 642 and the process is repeated. The periodic contact between the nubs 611 and the strike element 642 translates into an oscillating movement (wobbling motion) of the rotor 600.

It will be appreciated that the spacer 610 can be replaced with another spacer 610 of a different type when the rotor 600 is removed in the manner described hereinbefore. Thus, the user can easily vary the massaging action of the apparatus by substituting one spacer 610 with another spacer 610 that has different nub characteristics. FIG. 11 shows a spacer 610 without nubs 611 for a single mode massaging action. Further, a damper 660 can be provided for damping vibrations.

The apparatus also includes a resilient support (e.g., a resilient foam damper) that is disposed between the motor 14 and the housing 12 to permit the shaft 20 of the motor 14 to be displaced. The resilient support applies a restoring force that counters the displacement of the shaft due to the selective interaction between the nubs 611 and the strike element 642. As a result, when the nub 611 clears the strike element 642, the resilient support applies a restoring force to the shaft 20 so that it is restored to its initial relaxed position.

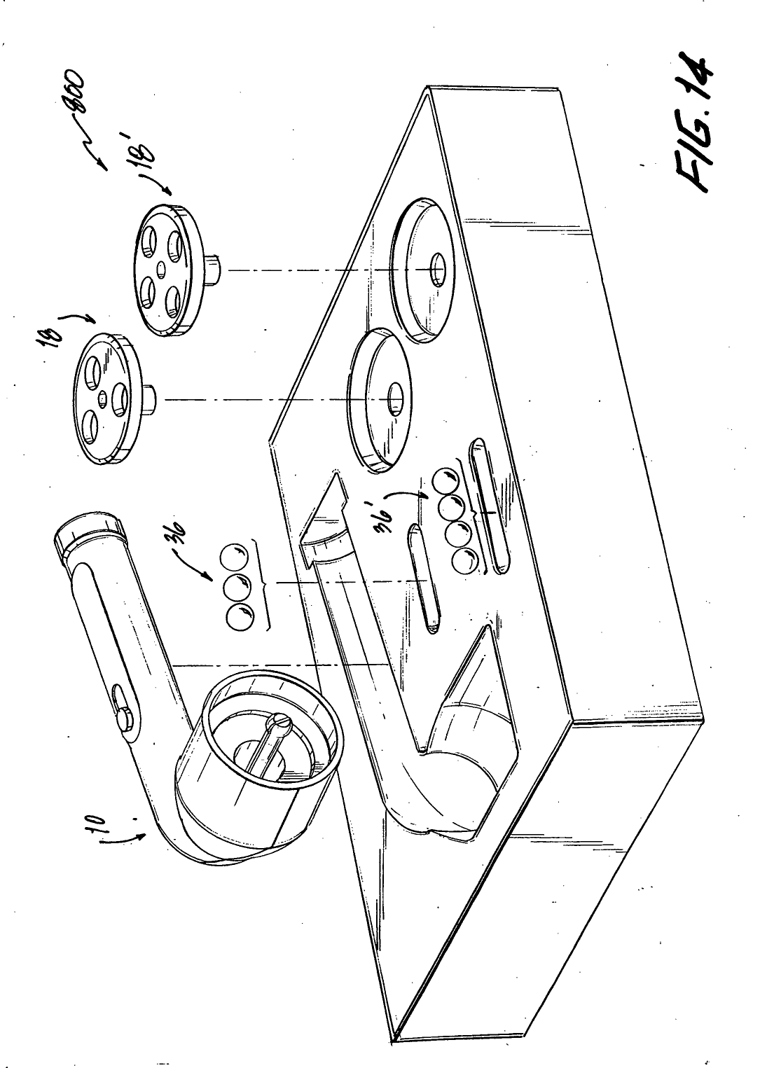

FIG. 13 illustrated yet another embodiment in which a palmheld apparatus 700 is illustrated. In this embodiment, the apparatus 700 has a base 710 that houses the electrical and control components as well as an energy source, such as a number of batteries 712 that are disposed within a battery compartment 714 and enclosed with a cover 716. The base 710 has a number of features that permit the user to easily grasp the base with one or more fingers. For example, finger slots 718 and a thumb slot 720 that has a control button 722 disposed therein to permit easy thumb activation of the apparatus. The other characteristics of the apparatus 700 are similar to earlier embodiments and therefore, are not described for purpose of brevity.

FIG. 14 illustrates a package construction 800 for holding apparatus 10 and a plurality of interchangeable rotors 18, 18′ as well as corresponding balls 36, 36′ that are used with the rotors.

The present therapeutic apparatus offers a more robust design in comparison to the prior art devices since the structures that hold the balls and prevent them from contacting the magnet are structurally more robust for supporting the balls to ensure that the balls remain in their desired positions. In addition, a dual mode massager is also disclosed to permit the user to obtain different massaging actions for treatment of the body.

While this invention has been particularly shown and described with references to preferred embodiments thereof, it will be understood by those skilled in the art that various changes in form and details may be made therein without departing from the scope of the invention encompassed by the appended claims.

1. An apparatus for applying massage, accupressure and biomagnetic therapy to a subject, the apparatus comprising:
a housing having a proximal end and a distal end;
a motor disposed within the housing and having a shaft;
a magnet disposed within the housing about the shaft;
a rotor rotatably supported by the shaft at the distal end of the housing, the rotor having an exterior face which is remote from the magnet and which defines a plurality of entrances, an opposing interior face proximate to the magnet, and a seat more proximate to the magnet than the interior face which is in communication with each of the entrances, each seat being affixed relative to the rotor at one or more locations proximal to the exterior face;
a plurality of metal balls which are seatable against the seat and retained within the entrances of the rotor solely by a magnetic field emanating from the magnet, each ball having a center and being universally rotatable about its center; and
wherein the seat precludes contact of the metal balls with the magnet and counters forces applied to the balls when the apparatus applies therapy to the subject.

2. The apparatus of claim 1, wherein the seat comprises a solid surface extending at least to the interior face of the rotor, and wherein the solid surface is free of any openings to the entrance.

3. The apparatus of claim 2, wherein the solid surface comprises a dome having a shape substantially complementary to the metal balls.

4. The apparatus of claim 1, wherein the seat comprises a substantially hemispherical surface extending at least to the inerior face of the rotor.

5. The apparatus of claim 4, wherein the hemispherical surface includes a plurality of windows formed therein.

6. The apparatus of claim 4, wherein the hemispherical surface has a concavity sized to receive at least a portion of the metal ball and wherein the concavity includes one or more bumps disposed thereupon, the bumps defining a contact surface for the metal balls.

7. The apparatus of claim 1, wherein the seat is affixed to the rotor at the interior face thereof.

8. The apparatus of claim 1, wherein the seat includes a finger which is affixed to the interior face of the rotor.

9. The apparatus of claim 8, wherein each support finger has one of a linear and an arcuate shape.

10. The apparatus of claim 8, wherein the seat includes a plurality of fingers each having one end connected to the seat and an opposite end affixed to the interior face of the rotor, the fingers and seat defining a cage for receiving the metal ball and countering forces applied to the balls when the apparatus supplies therapy to the subject.

11. The apparatus of claim 10, wherein each cage has an interior space in communication with a respective entrance and has a size sufficient to permit an associated metal ball to be received therein and a strength that counters forces applied to the balls when the apparatus supplies therapy to the subject.

12. The apparatus of claim 10, wherein adjacent fingers are spaced from one another.

13. The apparatus of claim 1, further comprising:
a resilient support between the motor and the housing permitting the shaft of the motor to be displaced;
a first feature associated with the housing and an interchangeable, second feature associated with the rotor,
wherein the first and second features are positioned so as to selectively interact upon rotation of the rotor, the interaction resulting in a displacement of the shaft against a restoring force of the resilient support,
whereby vibrations are imparted to the metal balls for applying an enhanced therapy to the subject.

14. The apparatus of claim 13, wherein the second feature is mounted so as to be stationary relative to the rotor.

15. The apparatus of claim 13, wherein the second feature comprises one of an element that is sized and shaped to interact with the first element upon rotation of the rotor and an element that is sized and shaped so as to be clear of the first element upon rotation of the rotor, whereby vibration can be selectively applied to the subject by upon exchanging one element for the second feature for another.

16. The apparatus of claim 1, further comprising a second motor coupled to the motor so as to introduce an oscillatory motion to the rotor upon actuation of the second motor.

17. The apparatus of claim 16, wherein one of the motor and the second motor is movably coupled to the housing.

18. The apparatus of claim 17, wherein the motor has a fixed first cam associated therewith and the second motor has a second cam associated therewith, wherein actuation of the second motor causes radial movement of the second cam resulting in the second cam striking the fixed first cam and the pivotal movement of the motor which results in axial displacement of the rotor from a rest position, the second motor having a biasing element associated therewith such that once the fixed first cam is free of engagement with the second cam, the second motor is naturally biased by the biasing element toward the rest position before the second cam strikes the fixed first cam again.

19. The apparatus of claim 16, wherein the second motor has a rotatble drive shaft with a platform attached at one end thereof, the second cam being formed on and extending outwardly from the platform.

20. The apparatus of claim 16, wherein the first motor is pivotally attached to the housing in such a way that the striking action between the first and second cams is translated into an oscillating motion for the rotor.

21. The apparatus of claim 16, wherein the second motor is disposed above the first motor with the first and second cams being in the same plane in the rest position and the fixed first cam is positioned with a radial path of the second cam.

22. The apparatus of claim 1, wherein the rotor has a collar that detachably interlocks with a sleeve associated with the shaft.

23. An apparatus for applying massage, accupressure and biomagnetic therapy to a subject, the apparatus comprising:
a housing having a proximal end and a distal end;
a motor disposed within the housing and having a shaft;
a magnet disposed within the housing about the shaft;
a rotor rotatably supported by the shaft at the distal end of the housing, the rotor having an exterior face which is remote from the magnet and which defines a plurality of entrances, an opposing interior face proximate to the magnet and which defines a plurality of exits, and a plurality of apertures extending from each entrance to a respective exit;
a plurality of metal balls each having a center and an outer diameter and being retained at least partially within one of the plurality of apertures solely by a magnetic field emanating from the magnet, each metal ball being supported for universal rotation about its respective center; and
a substantially continuous abutment disposed between each entrance and respective exit, the abutment engaging the metal balls and preventing the metal balls from contacting the magnet while simultaneously countering forces applied to the balls when the apparatus applies therapy to the subject.

24. The apparatus of claim 23, wherein the metal balls, once retained in the rotor, have their outer diameter recessed within the exterior face of the rotor such that more than 50% of the metal balls are within the plurality of apertures.

25. The apparatus of claim 23, wherein the rotor has a collar that detachably interlocks with a sleeve associated with the shaft.

26. The apparatus of claim 23, wherein the substantially continuous abutment comprises a taper extending into the apertures.

27. The apparatus of claim 23, wherein the substantially continuous abutment comprises a permanent, ring magnet affixed to the rotor with its magnetic poles arranged in opposite polarity to that of the magnet whereby the metal balls normally float in spaced relation to the ring magnet within the apertures.
